(19) United States
(12) Patent Application Publication
(10) Pub. No.: US 2014/0118243 A1
(43) Pub. Date: May 1, 2014

(54) DISPLAY SECTION DETERMINATION

(71) Applicant: UNIVERSITY OF SEOUL INDUSTRY COOPERATION FOUNDATION, Seoul (KR)

(72) Inventor: Jin Suk KIM, Seoul (KR)

(73) Assignee: University of Seoul Industry Cooperation Foundation, Seoul (KR)

(21) Appl. No.: 13/777,278

(22) Filed: Feb. 26, 2013

(30) Foreign Application Priority Data
Oct. 25, 2012 (KR) 10-2012-0119030

(51) Int. Cl. G02B 27/01

(52) U.S. Cl. CPC G02B 27/01
USPC 345/156

(57) ABSTRACT

A glasses may include a pupil movement sensor configured to detect a movement of a pupil within an eye, a processor configured to determine a display section based, at least in part, on the movement of the pupil, and a display configured to display the determined display section.

### CROSS-REFERENCE TO RELATED PATENT APPLICATION

This application claims priority from the Korean Patent Application No. 10-2012-0119030, filed on Oct. 25, 2012 in the Korean Intellectual Property Office, the entire disclosure of which is incorporated herein by reference in its entirety.

### FIELD

Example embodiments broadly relate to glasses and methods for determining a display section to be displayed on a display based on a movement of a pupil within an eye.

### BACKGROUND

There are various mechanisms for allowing a wearer to view a display without having to look down. For example, heads-up displays (HUDs) or head-mounted displays (HMDs) have been developed to allow a wearer to see an image on a display without looking down at a monitor or a screen of a computer. Recently, a glasses type of HUDs/HMDs is becoming more popular. However, with existing technology, a wearer of a HUD/HMD has to turn his/her head to change a section or area displayed on a display into a different section or area.

### SUMMARY

According to an aspect of example embodiments, there is provided a glasses including a pupil movement sensor configured to detect a movement of a pupil within an eye, a processor configured to determine a display section based, at least in part, on the movement of the pupil, and a display configured to display the determined display section.

The pupil movement sensor may be an inside image sensor configured to capture an image of the pupil within the eye.

The processor may be further configured to select the display section from a large-sized image based, at least in part, on the movement of the pupil within the eye.

The large-sized image may be transmitted from an outside of the glasses to the glasses via a network.

The glasses may further comprise: an outside image sensor configured to capture an outside image around the glasses. The large-sized image may be the outside image.

When the pupil movement sensor detects that the pupil moves toward a predetermined position within the eye, the display may be further configured to display additional information associated with the determined display section.

The glasses may further comprise: a glasses frame configured to detect a touch input to the glasses frame. The processor may be further configured to determine a pointing position within the display section based, at least in part, on the touch input.

The processor may be further configured to transmit the pointing position to the display, and the pointing position may be shown on the display section displayed by the display.

The glasses may further comprise: a lens, a part of which being configured to serve as the display. A position of the display within the lens may be changed in accordance with the detected movement of the pupil.

The glasses may further comprise: a non-transparent member. The display may be mounted on the non-transparent member.

The glasses may further comprise: an on/off switch configured to stop or start at least one operation of the display and the processor.

The glasses may further comprise: a plurality of outside image sensors configured to capture a plurality of images around the glasses. The processor may be further configured to select the display section from among the plurality of images captured by the plurality of outside image sensors based, at least in part, on the movement of the pupil within the eye.

The glasses may further comprise: a rotatable outside image sensor configured to capture an outside image around the glasses. The processor may be further configured to rotate the rotatable outside image sensor in accordance with the detected movement of the pupil, and the display section may be the outside image captured by the rotatable outside image sensor.

According to another aspect of example embodiments, a pupil position detector coupled with a glasses comprises: a pupil position sensor configured to detect a position of a pupil within an eye, and a transmitter configured to transmit the detected position to a display associated with the glasses.

According to another aspect of example embodiments, a method performed under control of a glasses comprises: detecting a movement of a pupil within an eye, determining a display section based, at least in part, on the movement of the pupil, and displaying the determined display section.

The method may further comprise: capturing a large-sized image around the glasses. The determining of the display section may comprise: detecting a position of the pupil within the eye based, at least in part, on the movement of the pupil, and selecting the display section from the captured large-sized image based, at least in part, on the position of the pupil within the eye.

The method may further comprise: capturing a plurality of images around the glasses. The determining of the display section may comprise: detecting a position of the pupil within the eye based, at least in part, on the movement of the pupil, and selecting the display section from among the plurality of images based, at least in part, on the position of the pupil within the eye.

The method may further comprise: receiving, from an outside of the glasses, a large-sized image via a network. The determining of the display section may comprise: detecting a position of the pupil within the eye based, at least in part, on the movement of the pupil, and selecting the display section from the captured large-sized image based, at least in part, on the position of the pupil within the eye.

The displaying of the determined display section may comprise: displaying the determined display section on a first area within a lens of the glasses, and displaying the determined display section on a second area within the lens of the glasses. The first area and the second area may be determined in accordance with the detected movement of the pupil.

According to another aspect of example embodiments, there is provided a non-transitory computer-readable storage medium having stored thereon computer-executable instructions that, in response to execution, cause a glasses to perform a method including detecting a movement of a pupil within an eye, determining a display section based, at least in part, on the movement of the pupil, and displaying the determined display section.

### BRIEF DESCRIPTION OF THE DRAWINGS

Non-limiting and non-exhaustive example embodiments will be described in conjunction with the accompanying drawings. Understanding that these drawings depict only example embodiments and are, therefore, not intended to limit its scope, the example embodiments will be described with specificity and detail taken in conjunction with the accompanying drawings, in which:

FIG. 1 schematically shows an illustrative example of glasses in accordance with at least some embodiments described herein;

FIG. 2 schematically shows an illustrative example of an outside view in front of a wearer in accordance with at least some embodiments described herein

FIGS. 3A to 3C schematically show an illustrative example of glasses displaying a display section determined based on a movement of a pupil in accordance with at least some embodiments described herein;

FIG. 4 schematically shows an illustrative example of glasses including a single outside image sensor in accordance with at least some embodiments described herein;

FIG. 5 schematically shows an illustrative example of glasses including a multiple number of outside image sensors in accordance with at least some embodiments described herein;

FIG. 6 schematically shows an illustrative example of glasses including a rotatable outside image sensor in accordance with at least some embodiments described herein;

FIG. 7 schematically show an illustrative example of glasses displaying additional information in accordance with at least some embodiments described herein;

FIG. 8 schematically shows an illustrative example of glasses detecting a touch input to a glasses frame in accordance with at least some embodiments described herein;

FIG. 9 schematically shows an illustrative example of glasses coupled with non-transparent member in accordance with at least some embodiments described herein;

FIG. 10 shows a schematic block diagram illustrating an architecture of a pupil position detector coupled with glasses in accordance with example embodiments described herein; and

FIG. 11 shows an example processing flow for determining a display section in accordance with example embodiments described herein.

### DETAILED DESCRIPTION

Hereinafter, some embodiments will be described in detail. It is to be understood that the following description is given only for the purpose of illustration and is not to be taken in a limiting sense. The scope of the invention is not intended to be limited by the embodiments described hereinafter with reference to the accompanying drawings, but is intended to be limited only by the appended claims and equivalents thereof.

It is also to be understood that in the following description of embodiments any direct connection or coupling between functional blocks, devices, components, circuit elements or other physical or functional units shown in the drawings or described herein could also be implemented by an indirect connection or coupling, i.e. a connection or coupling comprising one or more intervening elements. Furthermore, it should be appreciated that functional blocks or units shown in the drawings may be implemented as separate circuits in some embodiments, but may also be fully or partially implemented in a common circuit in other embodiments. In other words, the provision of functional blocks in the drawings is intended to give a clear understanding of the various functions performed, but is not to be construed as indicating that the corresponding functions are necessarily implemented in physically separate entities.

It is further to be understood that any connection which is described as being wire-based in the following specification may also be implemented as a wireless communication connection unless noted to the contrary.

The features of the various embodiments described herein may be combined with each other unless specifically noted otherwise. On the other hand, describing an embodiment with a plurality of features is not to be construed as indicating that all those features are necessary for practicing the present invention, as other embodiments may comprise less features and/or alternative features.

In some examples, glasses may detect a movement of a pupil of an eye, and then may determine a display section from an image based on the detected movement of the pupil. The image may be captured by at least one outside image sensor which is installed on the glasses, or may previously stored in a memory of the glasses, or may be transmitted to a communication unit of the glasses via a network from an outside of the glasses. Further, glasses may display the determined display section. When a wearer of the glasses moves his/her pupil while wearing the glasses, the glasses may detect the movement of the pupil of the wearer, and then provide the wearer with a view synchronized with the movement of the pupil.

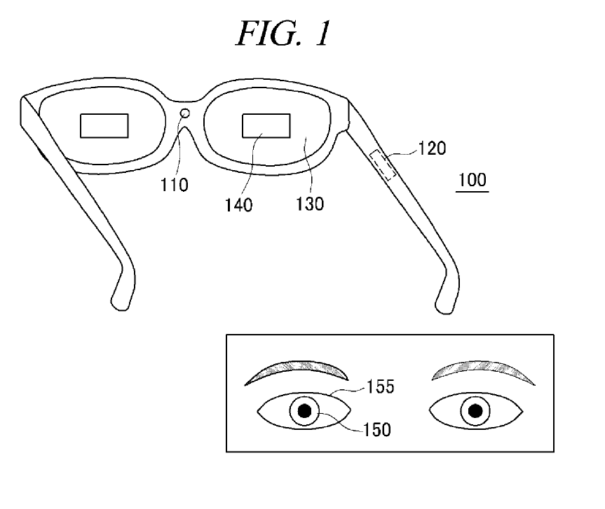

FIG. 1 schematically shows an illustrative example of glasses in accordance with at least some embodiments described herein. As depicted in FIG. 1, glasses 100 may include a pupil movement sensor 110, a processor 120, a lens 130 and a display 140. Although illustrated as discrete components, various components may be divided into additional components, combined into fewer components, or eliminated altogether while being contemplated within the scope of the disclosed subject matter.

Pupil movement sensor 110 may be coupled with or installed on glasses 100. For example, pupil movement sensor 110 may be positioned on an inner surface of a glasses bridge connecting a left lens with a right lens to face a pupil 150 within an eye 155. Pupil movement sensor 110 may detect a movement of pupil 150 within eye 155. By way of example, pupil movement sensor 110 may sense a position of pupil 150, so that the movement of pupil 150 can be detected based on changes in the sensed positions of pupil 150.

In some embodiments, pupil movement sensor 110 may include a light emitter, a light receiver and an analyzer. Specifically, the emitter may emit a light to pupil 150, and the receiver may receive the light reflected from pupil 150, and the analyzer may analyze changes in reflection based on the reflected light. According to such an optical method, the movement of pupil 150 can be detected.

In some embodiments, pupil movement sensor 110 may include an image sensor such as a charge-coupled device (CCD) sensor or a complementary metal-oxide-semiconductor (CMOS) sensor. The image sensor may capture an image of pupil 150, so that the movement of pupil 150 can be detected by analyzing the captured image.

Although glasses 100 in FIG. 1 are illustrated to have one pupil movement sensor 110, the number of pupil movement sensor 110 can be increased. By way of example, but not limited to, glasses 100 may have two pupil movement sensors to respectively detect a movement of a right pupil 150 within a right eye and a movement of a left pupil 150 within a left eye.

Processor 120 may determine a display section which will be displayed on display 140 based, at least in part, on the movement of pupil 150 detected by pupil movement sensor 110. In some embodiments, processor 120 may be installed inside of a glasses frame of glasses 100. By way of example, processor 120 may determine the display section from a large-sized image, and a part of the large-sized image may be selected as the determined display section. The image may be one of a two-dimensional image and a three-dimensional image.

In some embodiments, glasses 100 may previously store contents such as a movie, a television broadcasting program, a music video and so forth, and then the display section may be determined from an image included in the contents. Glasses 100 may further include a memory (not illustrated) that previously stores at least one image or contents. By way of example, but not limited to, the memory may include high speed random access memory, non-volatile memory such as one or more magnetic disk storage devices, flash memory devices, or other non-volatile solid state memory devices, network attached storage accessed or any suitable combination thereof.

In some embodiments, an outside image sensor (not illustrated) coupled with or installed on glasses 100 may capture an image, and then the display section may be determined from the captured image. By way of examples, the outside image sensor may include various image sensor lenses such as a wide-angle lens, a telephoto lens, a zoom lens, a fish-eye lens and a lens for infrared optics, and the outside image sensor may further include a filter installed on the image sensor lens. Glasses 100 may have a multiple number of outside image sensors to capture a wide image, a non-wobbly image or a three-dimensional image around glasses 100. Further, since display 130 displays the determined display section from the captured image which is an outside view around glasses 100, glasses 100 may be useful to a wearer who has poor eye sight.

In some other embodiments, glasses 100 may receive a real time broadcasting contents such as an IPTV contents from outside of glasses 100 via a network, and then the display section may be determined from an image included in the real time broadcasting contents.

The network is an interconnected structure of nodes, such as terminals and servers, and allows sharing of information among the nodes. By way of example, but not limited to, the network may include a wired network such as LAN (Local Area Network), WAN (Wide Area Network), VAN (Value Added Network) or the like, and all kinds of wireless network such as a mobile radio communication network, a satellite network, a Bluetooth, Wibro (Wireless Broadband Internet), Mobile WiMAX, HSDPA (High Speed Downlink Packet Access) or the like.

By way of example, if a wearer of glasses 100 move his/her pupil 150 toward the left side, process 120 may select a left section of the image as the display section which will be displayed on display 140. If the wearer of glasses 100 moves his/her pupil 150 toward the right side, process 120 may select a right section of the image as the display section which will be displayed on display 140.

Lens 130 may be coupled with glasses 100, and the wearer of glasses 100 may see something outside of glasses 100 such as a landscape, a monitor or a screen through lens 130. By way of example, lens 130 may include a glass panel, a transparent film, a transparent sheet and so forth.

Display 140 may be mounted on lens 130 coupled with glasses 100. For example, display 140 may be any kind of heads-up displays (HUDs) or head-mounted displays (HMDs). By way of example, display 140 may include a glass panel, a transparent film, a transparent sheet and so forth. In some embodiments, display 140 may be formed on lens 130, or a part of lens 120 may serve as display 140. The illustrated size or shape of display 140 can also be modified.

Display 140 may display the display section determined by processor 120. In some embodiments, a position of display 140 on lens 130 may be changed in accordance with the detected movement of pupil 150. By way of example, if the pupil 150 moves toward the left side, a position of display 140 may be moved to the left side on lens 130 in response to the detected movement of the pupil 150. Similarly, if the pupil 150 moves toward the right side, a position of display 140 may be moved to the right side on lens 130 in response to the detected movement of the pupil 150.

On a lower part of FIG. 1, eye 155 and pupil 150 within eye 155 are illustrated when viewed from a front side of the wearer of glasses 100.

Further, a projector (not illustrated) may be installed on a certain position of glasses 100 to shoot beams to a transparent display area on lens 120 of glasses 100 to display something on the transparent display area.

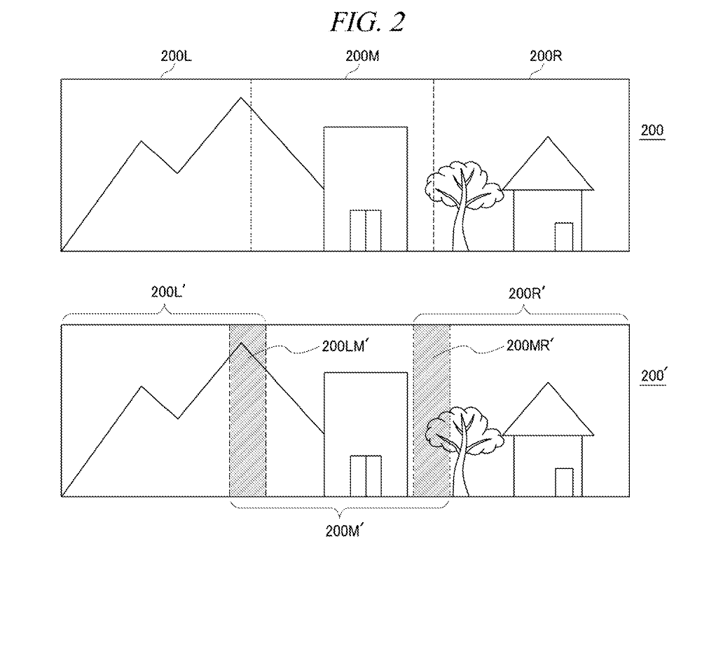

FIG. 2 schematically shows an illustrative example of an outside view in front of a wearer in accordance with at least some embodiments described herein. As depicted in FIG. 2, an outside view 200 may include a left section 200L, a middle section 200M and a right section 200R. If a wearer moves his/her pupil toward the left, the wearer may view left section 200L through a display. Similarly, if the wearer moves his/her pupil toward the middle or right, the wearer may view middle section 200M or right section 200R through the display.

Although adjacent sections 200L and 200M, or 200M and 200R are illustrated to have no overlapped area in FIG. 2, it will be understood by skilled in the art that adjacent sections 200L and 200M, or 200M and 200R may be overlapped with each other. By way of example, an outside view 200′ may include a left section 200L′, a middle section 200M′ and a right section 200R′. Even if the wearer moves his/her pupil toward the left or the middle, an overlapped area 200LM′ may be showed up in each case. Similarly, even if the wearer moves his/her pupil toward the middle or the right, an overlapped area 200MR′ may be showed up in each case.

Hereinafter, each section having no overlapped area will be described for the simplicity of explanation.

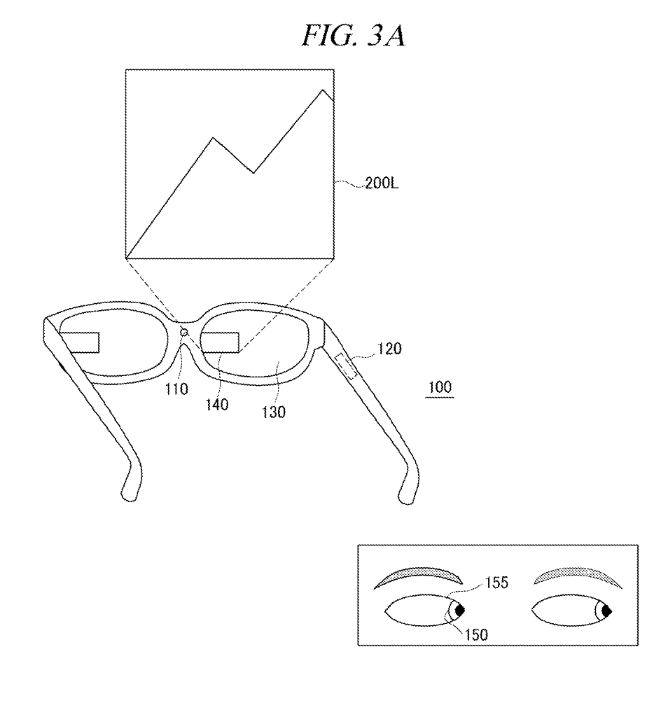

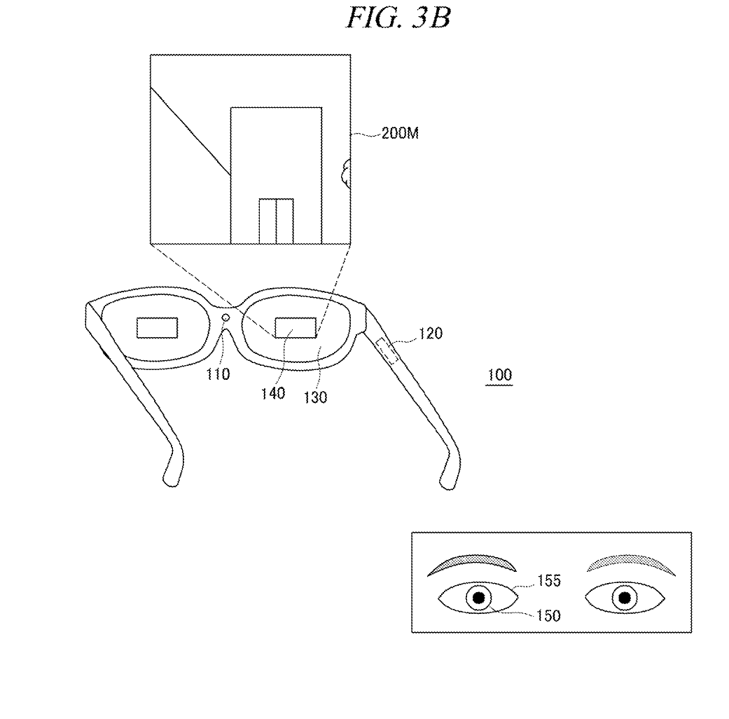

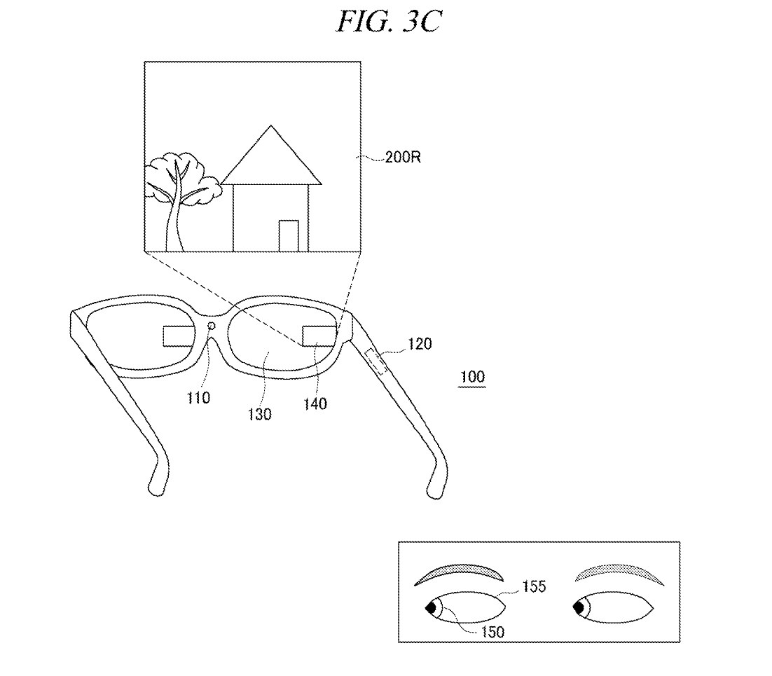

FIGS. 3A to 3C schematically show an illustrative example of glasses displaying a display section determined based on a movement of a pupil in accordance with at least some embodiments described herein. With respect to FIG. 3A to 3C, redundant description of pupil movement sensor 110, processor 120, lens 130 and display 140 discussed above in conjunction with FIG. 1 will be omitted herein.

As depicted in FIG. 3A, if the wearer of glasses 100 moves his/her pupil 150 within his/her eye 155 toward the left, left section 200L may be selected as the display section from outside view 200, and then the selected display section may be displayed on display 140. In some embodiments, a position of display 140 may be changed to the left side of lens 130 according to the movement of pupil 150.

Similarly, as depicted in FIG. 3B, if the wearer of glasses 100 moves his/her pupil 150 within his/her eye 155 toward the middle, middle section 200M may be selected as the display section from outside view 200, and then the selected display section may be displayed on display 140. In some embodiments, a position of display 140 may be changed to the middle side of lens 130 according to the movement of pupil 150.

Similarly, as depicted in FIG. 3C, if the wearer of glasses 100 moves his/her pupil 150 within his/her eye 155 toward the right, right section 200R may be selected as the display section from outside view 200, and then the selected display section may be displayed on display 140. In some embodiments, a position of display 140 may be changed to the right side of lens 130 according to the movement of pupil 150.

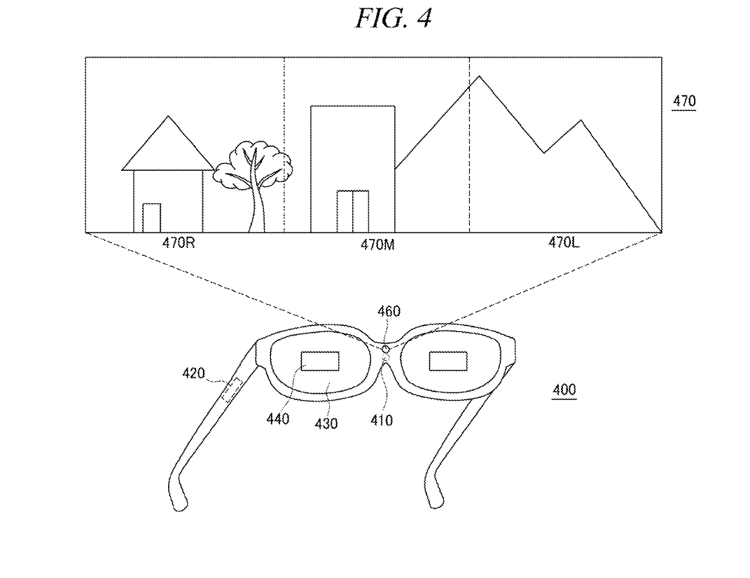

FIG. 4 schematically shows an illustrative example of glasses including a single outside image sensor in accordance with at least some embodiments described herein. As depicted in FIG. 4, glasses 400 may include a pupil movement sensor 410, a processor 420, a lens 430, a display 440 and an outside image sensor 460.

Since the function and operation of pupil movement sensor 410, processor 420, lens 430 and display 440 are similar to those of pupil movement sensor 110, processor 120, lens 130 and display 140 discussed above in conjunction with FIG. 1, redundant description thereof will be omitted herein.

Outside image sensor 460 may be coupled with or installed on glasses 400. By way of example, outside image sensor 460 may be positioned on an outer surface of a glasses bridge connecting a left lens with a right lens. Further, outside image sensor 460 may capture an outside image 470 around glasses 400. In this embodiment, a size of outside image 470 may be larger than a size of display 440, so that a part of outside image 470 may be displayed on display 440.

In FIG. 4, outside image 470 is illustrated when viewed from a wearer of glasses 400. Further, outside image 470 may include a right section 470R, a middle section 470M and a left section 470L. By way of example, if the wearer of glasses 400 moves his/her pupil toward the right, right section 470R may be selected from outside image 470 as a display section. Similarly, if the wearer of glasses 400 moves his/her pupil toward the middle, middle section 470M may be selected from outside image 470 as the display section, and if the wearer of glasses 400 moves his/her pupil toward the left, left section 470L may be selected from outside image 470 as the display section.

One of right section 470R, middle section 470M and left section 470L selected as the display section based on the movement of the pupil may be displayed by display 440.

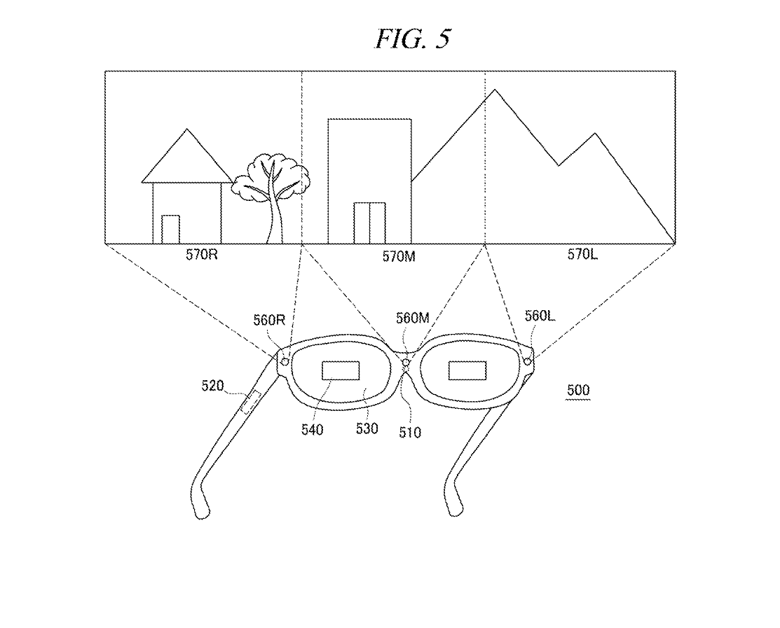

FIG. 5 schematically shows an illustrative example of glasses including a multiple number of outside image sensors in accordance with at least some embodiments described herein. As depicted in FIG. 5, glasses 500 may include a pupil movement sensor 510, a processor 520, a lens 530, a display 540, a right outside image sensor 560R, a middle outside image sensor 560M and a left outside image sensor 560L. As compared to glasses 400 of FIG. 4, glasses 500 may include multiple outside image sensors 560R, 560M and 560L instead of single outside image sensor 460 in FIG. 4.

Since the function and operation of pupil movement sensor 510, processor 520, lens 530 and display 540 are similar to those of pupil movement sensor 110, processor 120, lens 130 and display 140 discussed above in conjunction with FIG. 1, redundant description thereof will be omitted herein.

Pupil movement sensor 510 may detect a movement of a pupil within an eye, while right outside image sensor 560R may capture a right outside image 570R, and middle outside image sensor 560M may capture a middle outside image 570M, and left outside image sensor 560L may capture a left outside image 570L around glasses 500. Here, outside images 570R, 570M and 570L in FIG. 5 are illustrated when viewed from a wearer of glasses 500.

Then, processor 520 may select one of outside image sensors 560R, 560M and 560L based, at least in part, on the detected movement of the pupil, and then processor 520 may determine an outside image captured by the selected outside image sensor as a display section from among outside images 570R, 570M and 570L. By way of example, if the wearer of glasses 500 moves his/her pupil toward the right, right outside image 570R captured by right outside image sensor 560R may be determined as a display section. Similarly, if the wearer of glasses 500 moves his/her pupil toward the middle or left, middle outside image 570M captured by middle outside image sensor 560M or left section 570L captured by left outside image sensor 560L may be determined as the display section. Thereafter, the determined display section may be displayed by display 540.

Right outside image sensor 560R, middle outside image sensor 560M and left outside image sensor 560L may be coupled with or installed on glasses 500. By way of example, right outside image sensor 560R may be positioned on an outer surface of a right end piece connecting a right temple to a right lens, and middle outside image sensor 560M may be positioned on an outer surface of a glasses bridge connecting the lens to a left lens, and left outside image sensor 560L may be positioned on an outer surface of a left end piece connecting a left temple to the left lens.

Although three outside image sensors are illustrated in FIG. 5, the number of outside image sensors is not limited to three. By way of example, if glasses 500 have two outside image sensors, middle outside image sensor 560M can be omitted from glasses 500. Alternatively, the number of outside image sensors can be increased to capture more images around glasses 500.

In some embodiments, in order to save power consumption of glasses 500, at least one of outside image sensors 560R, 560M and 560L may be turned off when unnecessary. By way of example, when processor 520 detects the movement of the pupil toward the right, only right outside image sensor 560R may be turned on while middle and left outside image sensor 560R and 560 L are turned off.

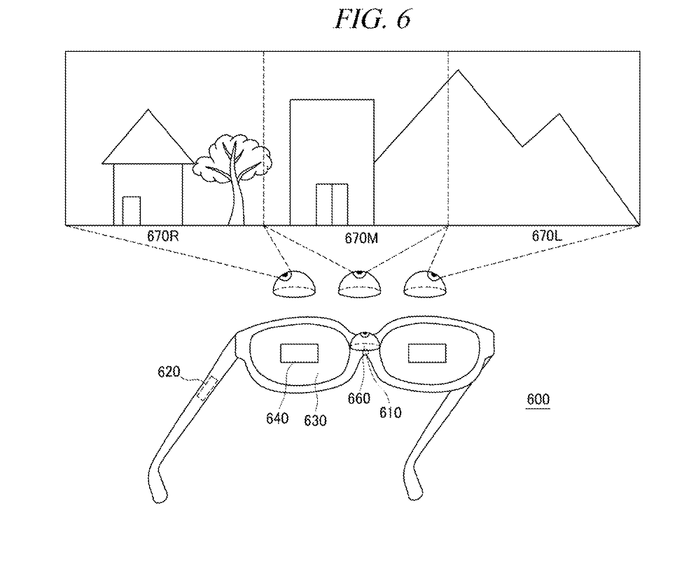

FIG. 6 schematically shows an illustrative example of glasses including a rotatable outside image sensor in accordance with at least some embodiments described herein. As depicted in FIG. 6, glasses 600 may include a pupil movement sensor 610, a processor 620, a lens 630, a display 640 and a rotatable outside image sensor 660. As compared to glasses 400 of FIG. 4, glasses 600 may include rotatable outside image sensor 660 instead of outside image sensor 460 in FIG. 4.

Since the function and operation of pupil movement sensor 610, processor 620, lens 630 and display 640 are similar to those of pupil movement sensor 110, processor 120, lens 130 and display 140 discussed above in conjunction with FIG. 1, redundant description thereof will be omitted herein.

Pupil movement sensor 610 may detect a movement of a pupil within an eye, and processor 620 may rotate rotatable outside image sensor 660 in accordance with the movement of the pupil detected by pupil movement sensor 610. By way of example, if a wearer of glasses 600 moves his/her pupil toward the right, rotatable outside image sensor 660 may be rotated to the right side. Similarly, if the wearer of glasses 600 moves his/her pupil toward the middle or left, rotatable outside image sensor 660 may be rotated to the middle side or left side. Further, processor 620 may determine an outside image captured by rotatable outside image sensor 660 as a display section, and then the determined display section may be displayed by display 640.

Rotatable outside image sensor 660 may be coupled with or installed on glasses 600. By way of example, rotatable outside image sensor 660 may be positioned on an outer surface of a glasses bridge connecting a left lens and a right lens. Further, rotatable outside image sensor 660 may capture an outside image around glasses 600. By way of example, rotatable outside image sensor 660 rotated to the right side may capture a right outside image 670R, rotatable outside image sensor 660 rotated to the middle side may capture a middle outside image 670M, and rotatable outside image sensor 660 rotated to the left side may capture a left outside image 670L around glasses 600. Here, right outside image 670R, middle outside image 670M and left outside image 670L in FIG. 6 are illustrated when viewed from the wearer of glasses 600.

In this embodiment, if the wearer of glasses 600 moves his/her pupil toward the right, right outside image 670R captured by rotatable outside image sensor 660 may be determined as a display section. Similarly, if the wearer of glasses 600 moves his/her pupil toward the middle or left, middle outside image 670M or left outside image 670L captured by rotatable outside image sensor 660 may be determined as the display section. Further, the determined display section may be displayed by display 640.

Although the outside view or the outside image is illustrated to have three sections in FIGS. 2 to 6, it will be understood by skilled in the art that the number of sections may not be limited to three. Further, as discussed above in conjunction with FIG. 2, each section may be overlapped with another section.

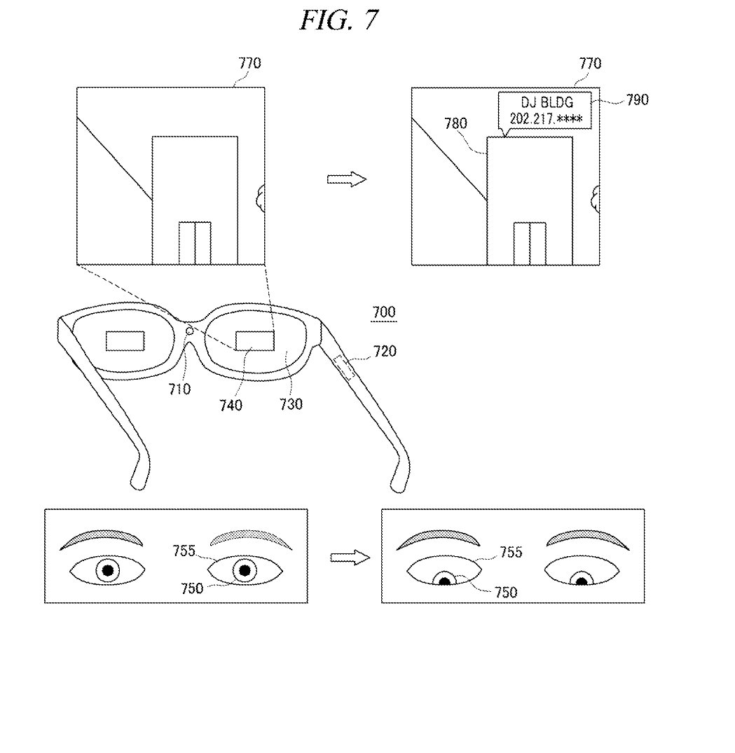

FIG. 7 schematically show an illustrative example of glasses displaying additional information in accordance with at least some embodiments described herein. As depicted in FIG. 7, glasses 700 may include a pupil movement sensor 710, a processor 720, a lens 730 and a display 740.

Since the function and operation of pupil movement sensor 710, processor 720, lens 730 and display 740 are similar to those of pupil movement sensor 110, processor 120, lens 130 and display 140 discussed above in conjunction with FIG. 1, redundant description thereof will be omitted herein.

In this embodiment, when pupil movement sensor 710 detects that pupil 750 moves toward a predetermined position within an eye 755, display 740 may display additional information associated with a display section 770. By way of example, when a wearer of glasses 700 moves pupil 750 toward a predetermined position such as a lower-middle position, pupil movement sensor 710 detects the movement toward the predetermined position, and then display 740 may display additional information 790 on display section 770. In this example, display section 770 shows on a building 780 therein and additional information 790 includes a name “DJ BLDG.” and a telephone number “202.217.****” associated with building 780. By way of example, displayed additional information may include a name, a telephone number, an address and a map of a certain object shown on display section 770.

Further, glasses 700 may receive additional information 790 on at least one object shown on display section 770 from an information providing server. In this embodiment, while viewing additional information 790 displayed on display 740, the wearer may find a particular spot such as a restaurant where the wearer wants to visit from a crowded street.

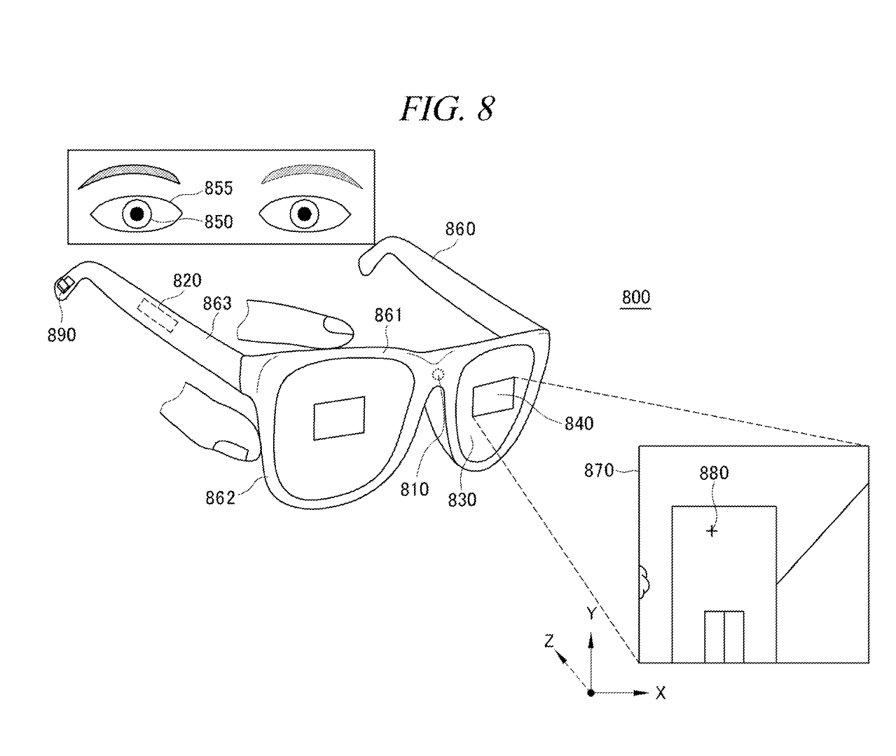

FIG. 8 schematically shows an illustrative example of glasses detecting a touch input to a glasses frame in accordance with at least some embodiments described herein. As depicted in FIG. 8, glasses 800 may include a pupil movement sensor 810, a processor 820, a lens 830, a display 840, a glasses frame 860 and an on/off switch 890.

Since the function and operation of pupil movement sensor 810, processor 820, lens 830 and display 840 are similar to those of pupil movement sensor 110, processor 120, lens 130 and display 140 discussed above in conjunction with FIG. 1, redundant description thereof will be omitted herein.

Glasses frame 860 may detect a touch input to glasses frame 860. The touch input to glasses frame 860 may be made by a wearer of glasses 800. By way of example, the touch input may be detected by using any of well-known touch sensitivity technologies, including but not limited to capacitive, resistive, infrared, and surface acoustic wave technologies, as well as other technologies using proximity sensor arrays or elements for sensing one or more contact points with glasses frame 860.

Further, glasses frame 860 may include a first glasses frame 861, a second glasses frame 862 and a third glasses frame 863. First glasses frame 861 may detect a first direction touch input to first glasses frame 861, and second glasses frame 862 may detect a second direction touch input to second glasses frame 862, and third glasses frame 863 may detect a third direction touch input to third glasses frame 863. In some embodiments, the first direction touch input may be associated with an x-axis direction on a display 840, and the second direction touch input may be associated with a y-axis direction on display 840, and the third direction touch input may be associated with a z-axis direction on display 840.

By way of example, as depicted in FIG. 8, if a display section 870 displayed on display 840 is a two-dimensional image, there is no need for detecting the third direction touch input to third glasses frame 813. Therefore, in such a case, it is sufficient to detect only the first direction touch input to first glasses frame 811, and the second direction touch input to second glasses frame 812.

Processor 820 may determine a pointing position 880 which will be shown on display section 870 based, at least in part, on the touch input that was made to glasses frame 860 by the wearer of glasses 800. Further, processor 820 may transmit determined pointing position 880 to display 840.

Pointing position 880 determined by processor 820 may be transmitted to display 840, and then transmitted pointing position 880 may be shown on display section 870 displayed by display 840.

On/off switch 890 may stop or start an operation of glasses 800. By way of example, if the wearer of glasses 800 wants to use a function of glasses 800 such as detecting a movement of a pupil 850 within an eye 855 and/or displaying display section 870 on display 840, the wearer may turn on on/off switch 890 and then the operation of glasses 800 may be started. Further, the wearer wants to stop to the operation of glasses 800, the wearer may turn off on/off switch 890 and then the operation of glasses 800 may be stopped. By way of example, but not limited to, on/off switch 890 may be a single button or two buttons including an “on” button and an “off” button. By way of example, if there is no operation of glasses 800 for a predetermined time, glasses 800 may be automatically switched to an “off” mode.

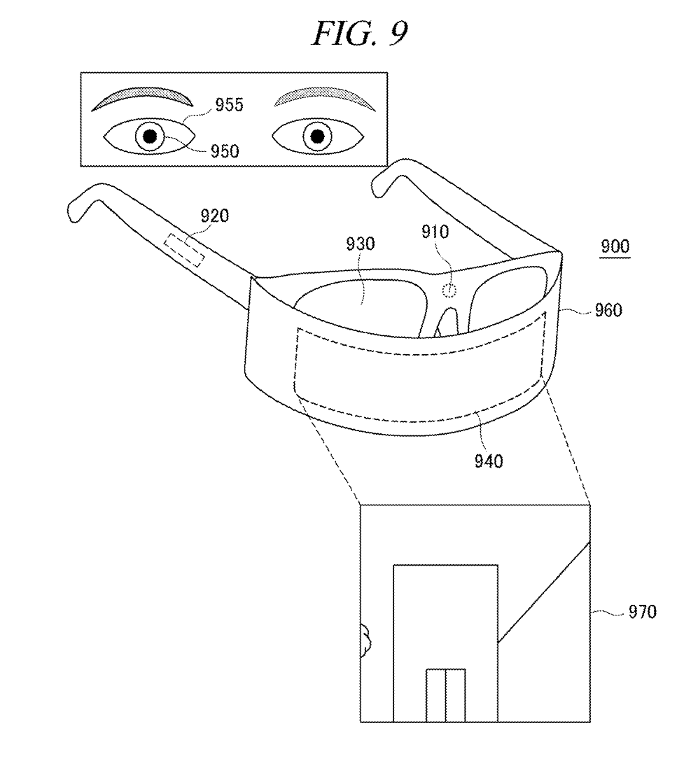

FIG. 9 schematically shows an illustrative example of glasses coupled with non-transparent member in accordance with at least some embodiments described herein. As depicted in FIG. 9, glasses 900 may include a pupil movement sensor 910, a processor 920, a lens 930, a display 940, and a non-transparent member 960. As compared to glasses 100 of FIG. 1, glasses 900 may further include non-transparent member 960, and display 940 which displays a display section 970 is mounted or formed on non-transparent member 960 not on lens 930. In this embodiment, lens 930 is optional and may be omitted from glasses 900.

Since the function and operation of pupil movement sensor 910, processor 920, lens 930 and display 940 are similar to those of pupil movement sensor 110, processor 120, lens 130 and display 140 discussed above in conjunction with FIG. 1, redundant description thereof will be omitted herein.

Non-transparent member 960 may be coupled with glasses 900. By way of example, but not limited to, non-transparent member 960 may be fixed to glasses 900, or configured to be moved up and down by a hinge provided to glasses 900. Display 940 may be mounted or formed on non-transparent member 960. If the wearer does not want to watch display 940, the wearer can move up non-transparent member 960 or remove non-transparent member 910.

Although, glasses 900 are illustrated to have a single display 940 in FIG. 9, in some embodiments, two displays may be mounted or formed on non-transparent member 960. By way of example, a first display may be mounted or formed on a right portion of non-transparent member 960, and a second display may be mounted or formed on a left portion of non-transparent member 960. By using these two displays, glasses 900 may provide the wearer with a 3-dimensional image.

Because glasses 900 maintain the wearer's peripheral vision free from obstruction, the wearer can view confidential information in a crowded environment without disclosing the displayed information to others. By way of example, in such a case, glasses 900 can allow the wearer to watch display section 970 on a private display 940. In some embodiments, glasses 900 may further include speakers or earphones to allow the wearer to listen sounds or voices.

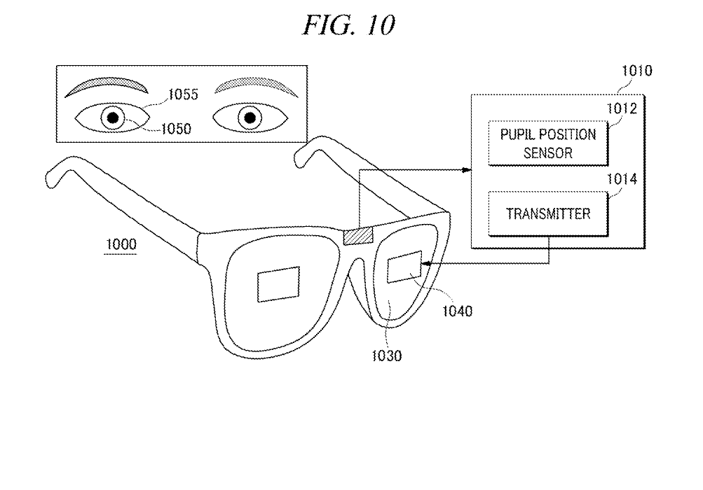

FIG. 10 shows a schematic block diagram illustrating an architecture of a pupil position detector coupled with glasses in accordance with example embodiments described herein. As depicted in FIG. 10, pupil position detector 1010 may be installed on glasses 1000, and pupil position detector 1010 may include a pupil position sensor 1012 and a transmitter 1014. Although illustrated as discrete components, various components may be divided into additional components, combined into fewer components, or eliminated altogether while being contemplated within the scope of the disclosed subject matter.

Pupil position sensor 1012 may detect a position of a pupil 1050 within an eye 1055. By way of example, pupil position sensor 1012 may be an inside image sensor. Further, transmitter 1014 may transmit the detected position of pupil 1050 to a display 1040.

Display 1040 may display a display section determined based, at least in part, on the transmitted position of pupil 1050. Further, display 1040 may be positioned on a lens 1030 fixed to glasses 1000. In some embodiments, but not limited to, display 1040 may be a separate display, and the separate display may include a monitor, a television, or a screen which is associated with various electronic devices such as a computer, a mobile device, or a beam projector.

By way of example, the computer may include a notebook provided with a WEB Browser, a desktop, a laptop, and others. The mobile device is, for example, a wireless communication device assuring portability and mobility and may include any types of handheld-based wireless communication devices such as a personal communication system (PCS), global system for mobile communications (GSM), personal digital cellular (PDC), personal handy phone system (PHS), personal digital assistant (PDA), international mobile telecommunication (IMT)-2000, code division multiple access (CDMA)-2000, W-code division multiple access (W-CDMA), a wireless broadband Internet (Wibro) device, and a smart phone.

By installing pupil position detector 1010 on glasses 1000, typical glasses 1000 may perform functions including detecting a position of pupil 1050 and transmitting the detected position as done by glasses 100 of FIG. 1.

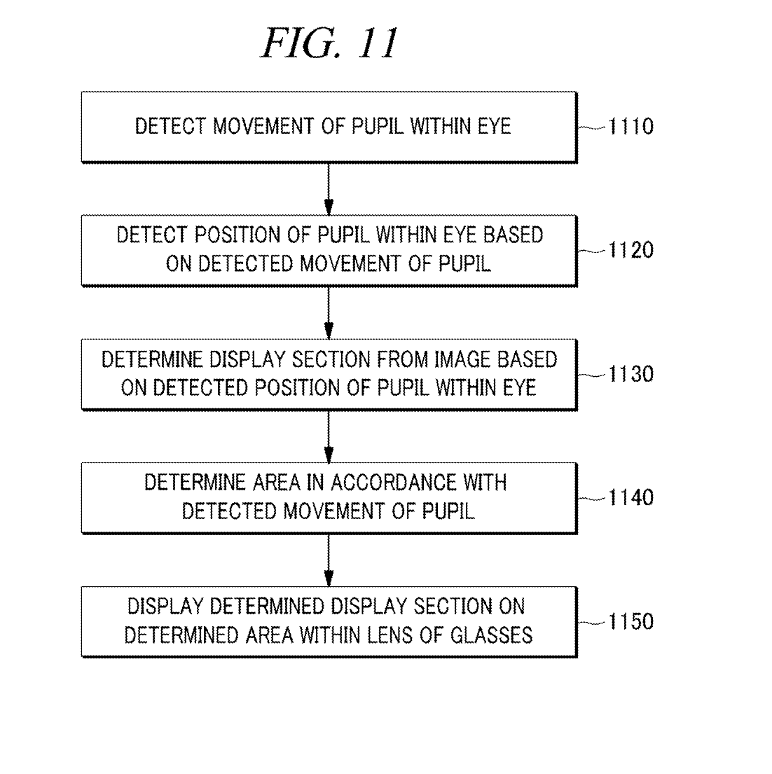

FIG. 11 shows an example processing flow for determining a display section in accordance with example embodiments described herein. The processing flow in FIG. 11 may be implemented by at least one glasses illustrated in FIGS. 1 to 10. Although illustrated as discrete blocks, various blocks may be divided into additional blocks, combined into fewer blocks, or eliminated, depending on the desired implementation. Processing may begin at block 1110.

At block 1110 (Detect Movement of Pupil), glasses may detect a movement of a pupil within an eye. By way of examples, the glasses may include a light emitter/receiver or an image sensor as a pupil movement sensor to detect the movement of the pupil. Processing may proceed from block 1110 to block 1120.

At block 1120 (Detect Position of Pupil), the glasses may detect a position of the pupil within the eye based, at least in part, on the movement of the pupil detected at block 1110. Alternatively, it is also possible that glasses may detect a position of the pupil within the eye at block 1110, and then the glasses may detect a movement of the pupil at block 1120 based, at least in part, on the change in positions of the pupil detected at block 1110. Processing may proceed from block 1120 to block 1130.

At block 1130 (Determine Display Section), the glasses may determine a display section based, at least in part, on the position or movement of the pupil within the eye detected at block 1110 or 1120. By way of examples, but not limited to, the display section may be determined by selecting an image from among multiple images or selecting a particular section from a large-sized image. Further, the image may be previously stored in a memory of the glasses, or may be captured by at least one outside image sensor installed on the glasses, or may be transmitted from an image providing server to the glasses via a network. Processing may proceed from block 1130 to block 1140.

At block 1140 (Determine Area), in some embodiments, the glasses may determine an area on a lens, where the display section will be positioned, according to the position or movement of pupil detected at block 1110 or 1120. By way of example, but not limited to, if the position of the pupil is detected at the right side within the eye, the area may be determined at a right side of the lens. Processing may proceed from block 1140 to block 1150.

At block 1150 (Display Display Section), the glasses may display the display section, determined at block 1130, on the area within the lens of glasses determined at block 1140.

The examples described above, with regard to FIGS. 1-11, may be implemented in a computing environment having components that include, but are not limited to, one or more processors, system memory, and a system bus that couples various system components. Further, the computing environment may include a variety of computer readable media that are accessible by any of the various components, and includes both volatile and non-volatile media, removable and non-removable media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, but not limitation, computer readable media may comprise computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal, such as carrier wave or other transport mechanism. Communication media also includes any information delivery media. The term modulated data signal means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

What is claimed is:

1. A glasses, comprising:
a pupil movement sensor configured to detect a movement of a pupil within an eye;
a processor configured to determine a display section based, at least in part, on the movement of the pupil; and
a display configured to display the determined display section.

2. The glasses of claim 1, wherein the pupil movement sensor is an inside image sensor configured to capture an image of the pupil within the eye.

3. The glasses of claim 1, wherein the processor is further configured to select the display section from a large-sized image based, at least in part, on the movement of the pupil within the eye.

4. The glasses of claim 3, wherein the large-sized image is transmitted from an outside of the glasses to the glasses via a network.

5. The glasses of claim 3, further comprising:
an outside image sensor configured to capture an outside image around the glasses,
wherein the large-sized image is the outside image.

6. The glasses of claim 1, wherein when the pupil movement sensor detects that the pupil moves toward a predetermined position within the eye, the display is further configured to display additional information associated with the determined display section.

7. The glasses of claim 1, further comprising:
a glasses frame configured to detect a touch input to the glasses frame,
wherein the processor is further configured to determine a pointing position within the display section based, at least in part, on the touch input.

8. The glasses of claim 7, wherein the processor is further configured to transmit the pointing position to the display, and
the pointing position is shown on the display section displayed by the display.

9. The glasses of claim 1, further comprising:
a lens, a part of which being configured to serve as the display;
wherein a position of the display within the lens is changed in accordance with the detected movement of the pupil.

10. The glasses of claim 1, further comprising:
a non-transparent member,
wherein the display is mounted on the non-transparent member.

11. The glasses of claim 1, further comprising:
an on/off switch configured to stop or start at least one operation of the display and the processor.

12. The glasses of claim 1, further comprising:
a plurality of outside image sensors configured to capture a plurality of images around the glasses,
wherein the processor is further configured to select the display section from among the plurality of images captured by the plurality of outside image sensors based, at least in part, on the movement of the pupil within the eye.

13. The glasses of claim 1, further comprising:
a rotatable outside image sensor configured to capture an outside image around the glasses,
wherein the processor is further configured to rotate the rotatable outside image sensor in accordance with the detected movement of the pupil, and
the display section is the outside image captured by the rotatable outside image sensor.

14. A pupil position detector coupled with a glasses, comprising:
a pupil position sensor configured to detect a position of a pupil within an eye; and
a transmitter configured to transmit the detected position to a display associated with the glasses.

15. A method performed under control of a glasses, comprising:
detecting a movement of a pupil within an eye;
determining a display section based, at least in part, on the movement of the pupil; and
displaying the determined display section.

16. The method of claim 15, further comprising:
capturing a large-sized image around the glasses,
wherein the determining of the display section comprises:
detecting a position of the pupil within the eye based, at least in part, on the movement of the pupil; and
selecting the display section from the captured large-sized image based, at least in part, on the position of the pupil within the eye.

17. The method of claim 15, further comprising:
capturing a plurality of images around the glasses,
wherein the determining of the display section comprises:
detecting a position of the pupil within the eye based, at least in part, on the movement of the pupil; and
selecting the display section from among the plurality of images based, at least in part, on the position of the pupil within the eye.

18. The method of claim 15, further comprising:
receiving, from an outside of the glasses, a large-sized image via a network,
wherein the determining of the display section comprises:
detecting a position of the pupil within the eye based, at least in part, on the movement of the pupil; and
selecting the display section from the captured large-sized image based, at least in part, on the position of the pupil within the eye.

19. The method of claim 15, wherein the displaying of the determined display section comprises:
displaying the determined display section on a first area within a lens of the glasses; and
displaying the determined display section on a second area within the lens of the glasses,
wherein the first area and the second area are determined in accordance with the detected movement of the pupil.

20. A non-transitory computer-readable storage medium having stored thereon computer-executable instructions that, in response to execution, cause a glasses to perform a method as claimed in claim 15.
